(19) United States
(12) Patent Application Publication
(10) Pub. No.: US 2007/0179770 A1
(43) Pub. Date: Aug. 2, 2007

(54) Automatically retaining settings of computations on models of molecules for automatic use in subsequent computations

(76) Inventor: David A. Gallagher, Portland, OR (US)

Correspondence Address: BAKER BOTTS L.L.P., 2001 ROSS AVENUE, SUITE 600, DALLAS, TX, 75201-2980, US

(21) Appl. No.: 11/345,731

(22) Filed: Feb. 1, 2006

(51) Int. Cl. G06G 7/48; G06G 7/58

(52) U.S. Cl. 703/11; 703/12

(57) ABSTRACT

In one embodiment, a method for automatically retaining one or more settings of a computation on a model of a molecule for automatic use in a subsequent computation includes automatically recording one or more first settings of a first computation on a model of a molecule. The first computation generates first data useable to assess one or more first properties of the molecule. The method includes automatically loading one or more of the first settings into a second computation on the model. The second computation generates second data useable to assess one or more second properties of the molecule, and retention of one or more of the first settings facilitates comparability between the first data resulting from the first computation and the second data resulting from the second computation.

### TECHNICAL FIELD OF THE INVENTION

This invention relates in general to computational chemistry and more particularly to automatically retaining settings of computations on models of molecules for automatic use in subsequent computations.

### BACKGROUND OF THE INVENTION

Computational chemistry typically involves the use of computer systems to generate partial or complete models of molecules and determine, verify, or otherwise assess properties of the molecules according to the generated models. The computations for assessing the properties are usually complex and often involve large numbers of settings.

### SUMMARY OF THE INVENTION

Particular embodiments of the present invention may reduce or eliminate problems and disadvantages associated with previous systems and methods for computational chemistry.

In one embodiment, a method for automatically retaining one or more settings of a computation on a model of a molecule for automatic use in a subsequent computation includes automatically recording one or more first settings of a first computation on a model of a molecule. The first computation generates first data useable to assess one or more first properties of the molecule. The method includes automatically loading one or more of the first settings into a second computation on the model. The second computation generates second data useable to assess one or more second properties of the molecule, and retention of one or more of the first settings facilitates comparability between the first data resulting from the first computation and the second data resulting from the second computation.

Particular embodiments of the present invention may provide one or more technical advantages. As an example, particular embodiments may reduce difficulties typically associated with entering the settings of a computation on a model of a molecule. Particular embodiments may reduce or eliminate the likelihood of errors in the entry of the settings of a such a computation. Particular embodiments may reduce time requirements typically associated with entering the settings of such a computation. Particular embodiments may cause data resulting from a series of computations on a model of a molecule to be more useful. Particular embodiments may provide all, some, or none of these technical advantages. Particular embodiments may provide one or more other technical advantages, one or more of which may be readily apparent to those skilled in the art from the figures, descriptions, and claims herein.

### BRIEF DESCRIPTION OF THE DRAWINGS

To provide a more complete understanding of the present invention and features and advantages thereof, reference is made to the following description, taken in conjunction with the accompanying drawings, in which:

FIG. 1 illustrates an example system for automatically retaining settings of computations on models of molecules for automatic use in subsequent computations;

FIG. 2 illustrates an example graphical user interface (GUI) for entering settings of computations; and

FIG. 3 illustrates an example method for automatically retaining settings of computations on models of molecules for automatic use in subsequent computations.

### DESCRIPTION OF EXAMPLE EMBODIMENTS

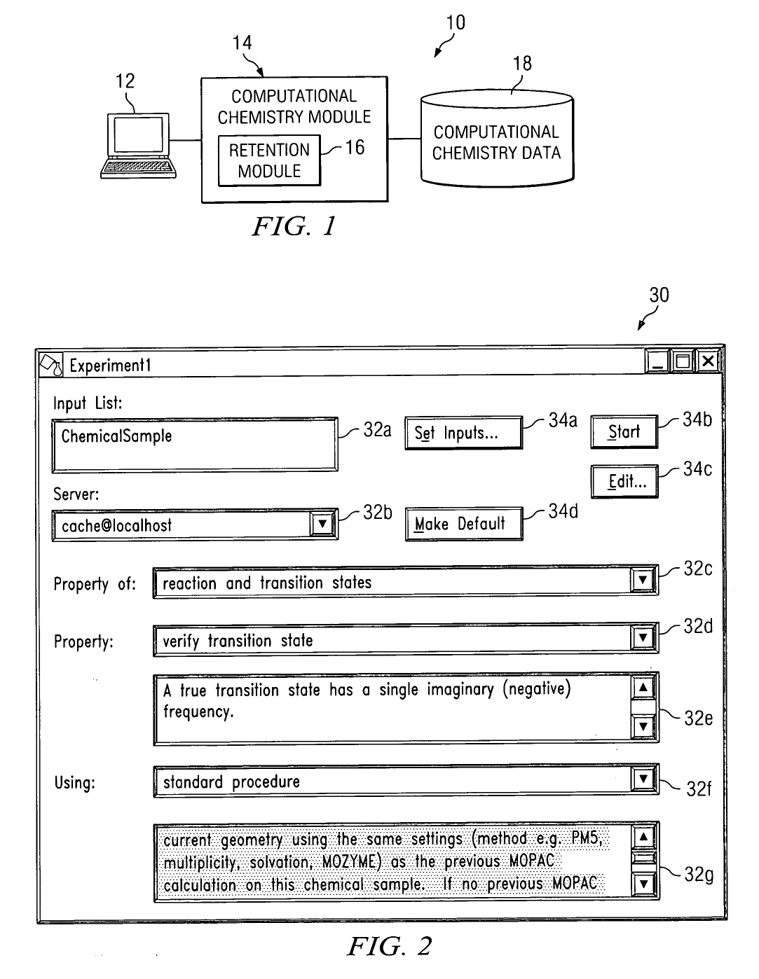

FIG. 1 illustrates an example system 10 for automatically retaining settings of computations on models of molecules for automatic use in subsequent computations. System 10 includes a computer system 12 and a computational chemistry module 14. Reference to a “module” encompasses a hardware, software, or embedded-logic component or a combination of two or more such components, where appropriate. Reference to “computational chemistry” encompasses any research in any branch of theoretical or experimental science that involves the use of computer-generated models of molecules to determine, predict, verify, or otherwise assess properties of molecules. In particular embodiments, computational chemistry involves three-dimensional geometry optimization, assessing properties resulting from three-dimensional structures, or both. Reference to a “model” of a molecule encompasses a partial model of the molecule, a complete model of the molecule, or both, where appropriate. The present invention contemplates any suitable models of any suitable molecules. Reference to a “property” of a molecule encompasses one or more properties of the molecule, one or more behaviors of the molecule, or both, where appropriate. The present invention contemplates any suitable properties of any suitable molecules.

Computer system 12 enables a user to provide input to and receive output from computational chemistry module 14. In particular embodiments, computer system 12, computational chemistry module 14, or both include one or more modules for generating one or more GUIs for providing input to and receiving output from computational chemistry module 14, as described more fully below. In particular embodiments, computational chemistry module 14 generates one or more models of one or more molecules according to input from a user and then runs computations on the models to assess one or more properties of the molecules. As an example and not by way of limitation, in response to input from a user, computational chemistry module 14 may generate a model of a molecule and run one or more computations on the model to assess one or more gas-phase behaviors of the molecule. As another example, computational chemistry module 14 may run one or more computations on the model to assess one or more properties of the molecule when dissolved in water or another solvent. The present invention contemplates any suitable computations on any suitable models of any suitable molecules to assess any suitable properties of the molecules. In particular embodiments, computational chemistry module 14 runs computations on models of molecules generated by one or more components that are partially or entirely separate from computational chemistry module 14.

A computation on a model of a molecule typically involves a large number of settings. Reference to a “setting” of a computation encompasses one or more defining characteristics of the computation, where appropriate. As an example and not by way of limitation, one or more settings of a computation may specify one or more parameter sets. A parameter set or Hamiltonian (such as, for example, AM1, PM3, or PM5) may define a computational method. As another example, one or more settings of a computation may specify one or more multiplicities. A multiplicity (such as, for example, singlet, doublet, triplet, or unrestricted hartree fock (UHF)) may indicate an electronic, or excited, state of a molecule. As yet another example, one or more settings of a computation may specify one or more environments. An environment may include a solvent field, such as, for example, solution in water or another solvent. As yet another example, one or more settings of a computation may specify one or more geometry optimization methods.

As yet another example, one or more settings of a computation may specify one or more convergence criteria. As yet another example, one or more settings of a computation may specify one or more configuration interaction settings. A configuration interaction setting may determine accuracy of one or more results of a computation. As yet another example, one or more settings of a computation may specify one or more key words, such as, for example, special-case geometry corrections (such as, for example, an amide-linkage geometry-correction group). The present invention contemplates any suitable settings of any suitable computations on any suitable models of any suitable molecules. The present invention is not limited to the particular settings described above. Particular embodiments of the present invention involve all the particular settings described above. Particular embodiments of the present invention involve only some of the particular settings described above. Particular embodiments of the present invention involve none of the particular settings described above. Particular embodiments of the present invention involve one or more settings not described above.

To assess a molecule, a user typically runs multiple computations on a model of the molecule. As an example and not by way of limitation, a user may run one or more first computations on a model of a molecule to assess one or more gas-phase behaviors of the molecule. After the user has finished the first computations, the user may run one or more second computations on the model to assess one or more properties of the molecule when dissolved in water or another solvent. Each of the computations typically takes a relatively long time to finish.

To ensure consistency throughout the data resulting from the computations, the user typically wants only a few of the settings of the computations to change from one computation to the next and wants the other settings to remain unchanged. As an example and not by way of limitation, as described above, a user may run one or more first computations on a model of a molecule to assess one or more gas-phase behaviors of the molecule and then run one or more second computations on the model to assess one or more properties of the molecule when dissolved in water or another solvent. The user may want only a few of the settings of the second computations to differ from the settings of the first computations. The user may want most of the settings of the settings of the second computations to exactly match the settings of the first computations. Consistency throughout the data resulting from the computations facilitates the usefulness of comparisons among the data. If, as a result of one or more errors, one or more of the settings that the user wanted to remain unchanged did not remain unchanged, the data resulting from the computations would be much less useful.

Because computations on a model of a molecule typically involve large numbers of settings, manually entering the settings of a computation without error is often very difficult. Manually entering the settings of each computation in a series of computations without error is even more difficult. Often, a user manually entering the settings of a computation has to review the settings of one or more previous computations and exactly recreate almost all the settings of the previous computations. Because of the difficulty associated with manually entering the settings of a computation, a user manually entering the settings may enter one or more of the settings incorrectly. One or more such errors may render the data resulting from a series of computations on a model of a molecule effectively useless. Each computation may require substantial computational resources (such as, for example, processor time) and, assuming the user even detects the errors, the user may have to run one or more of the computations again. If the user failed to detect the errors, the data resulting from the series of computations would be faulty, and reliance on the data would adversely affect further research on the molecule.

System 10 also includes retention module 16. The present invention contemplates any suitable arrangement between computational chemistry module 14 and retention module 16. As an example and not by way of limitation, retention module 16 may be a component of computational chemistry module 14. As another example, computational chemistry module 14 and retention module 16 may be partially or entirely separate from each other and coupled to each other for communication between them. In particular embodiments, to facilitate entering the settings of a computation, retention module 16 automatically records one or more of settings of a computation and automatically sets up one or more subsequent computations according to one or more of the recorded settings. As an example and not by way of limitation, in response to input from a user, computational chemistry module 14 may generate and store a model of a molecule for a series of computations. The user may want to run one or more first computations on the model to assess one or more gas-phase behaviors of the molecule and one or more second computations on the model to assess one or more properties of the molecule when dissolved in water or another solvent. The first computations may require one or more first settings and the second computations may require one or more second settings, according to particular needs. A few of the second settings may need to differ from the first settings, while most of the second settings may need to exactly match the first settings.

To run the first computations on the model, the user may cause computational chemistry module 14 to generate a GUI for entering the first settings. The GUI may enable the user to manually enter one or more of the first settings. The GUI may present one or more default settings that the user may select, deselect, or modify for use as one or more of the first settings. After the user has finished entering the first settings, retention module 16 may automatically save the first settings. Computational chemistry module 14 may then run the first computations according to the first settings and save the resulting data. To run the second computations on the model, the user may cause computational chemistry module 14 to generate a GUI for entering the second settings. Retention module 16 may automatically access the first settings and load them into the GUI. As a result of retention module 16 automatically loading the first settings into the GUI, the user need only modify a few of the settings in the GUI by retention module 16 to produce the second settings. The user may then indicate that the user has finished entering the second settings, and computational chemistry module 14 may run the second computations according to the second settings and save the resulting data. In particular embodiments, retention module 16 automatically writes the settings of one or more computations to a file that will include the results of the computations. The user who has run the computations may communicate the file to one or more other users at one or more other computer systems 12 coupled to one or more computational chemistry modules 14, and the other users may set up their own further computations according to the settings in the file.

In particular embodiments, computational chemistry data 18 includes models of molecules, settings of computations, data resulting from computations, or a combination of the preceding. As an example and not by way of limitation, computational chemistry module 14, one or more other components, or both may generate a model of a molecule according to input from a user and write the model to a memory containing computational chemistry data 18. Computational chemistry module 14 may read computational chemistry data 18 describing the model from the memory to run one or more computations on the model. As another example, computation chemistry data 18 may include one or more default settings that retention module 16 may load into a computation. As yet another example, after a user has entered one or more settings of a computation, retention module 16 may write the settings to a memory containing computational chemistry data 18. Retention module may read computational chemistry data 18 describing the settings from the memory to load the settings into a computation. As yet another example, after computational chemistry module 14 has run a computation on a model of a molecule, computational chemistry module 14 may write data resulting from the computation to a memory containing computational chemistry data 18. In particular embodiments, computational chemistry data 18 describing settings of previous computations is not deleteable or overwriteable.

In particular embodiments, a series of computations on a model of a molecule has a history file in computation chemistry data 18. To record one or more settings of a computation in the series, retention module 16 writes the settings to the history file. To set up a subsequent computation in the series, retention module accesses the history file and loads one or more of the settings in the history file into the subsequent computation. In particular embodiments, retention module 16 enables a user to modify one or more of the settings loaded into the subsequent computation before computational chemistry module 14 runs the subsequent computation. In particular embodiments, after computational chemistry module 14 has run the subsequent computation, computational chemistry module 14, retention module 16, or both writes one or more of the results of the computation to the history file. The present invention contemplates any suitable history files.

In particular embodiments, history files are indexed by molecule, calculation, or both. In particular embodiments, computational chemistry data 18 includes multiple history files. As an example and not by way of limitation, computational chemistry data 18 may include a first history file, a second history file, and a third history file. The first history file may correspond to a first series of computations on a first model of a first molecule, the second history file may correspond to a second series of computations on a second model of a second molecule, and the third history file may correspond to a third series of computations on a third model of a third molecule. Alternatively, the first history file may correspond to a first series of computations on a first model of a first molecule, the second history file may correspond to a second series of computations on a second model of the first molecule, and the third history file may correspond to a third series of computations on a third model of first molecule. The present invention contemplates any suitable computational chemistry data 18. The present invention contemplates any suitable memory for storing computational chemistry data 18 according to any suitable arrangement.

The present invention contemplates any suitable arrangement among computer system 12, computational chemistry module 14, and computational chemistry data 18. As an example and not by way of limitation, computational chemistry module 14 may be a component of computer system 12. As another example, computer system 12 and computational chemistry module 14 may be partially or entirely separate from each other and coupled to each other for communication between them. As yet another example, one or more components of computer system 12 may store computational chemistry data 18. As yet another example, one or more components partially or entirely separate from computer system 12, but accessible from computer system 12, computational chemistry module 14, or both, may store computational chemistry data 18.

FIG. 2 illustrates an example GUI 30 for entering settings of computations. In particular embodiments, GUI 30 is an experiment menu. GUI 30 includes fields 32 and icons 34. As an example and not by way of limitation, each field 32 may correspond to one or more settings that a user, retention module 16, or both may enter, modify, or both. One or more fields 32 in GUI 30 may include a drop-down list that includes settings a user may select. The user may select one or more icons 34 to provide input to computational chemistry module 14, retention module 16, or both causing one or both to carry out one or more tasks, provide the user one or more further options, or both. The present invention is not limited to any particular GUI 30 and contemplates any suitable GUI 30 for entering the settings of a computation.

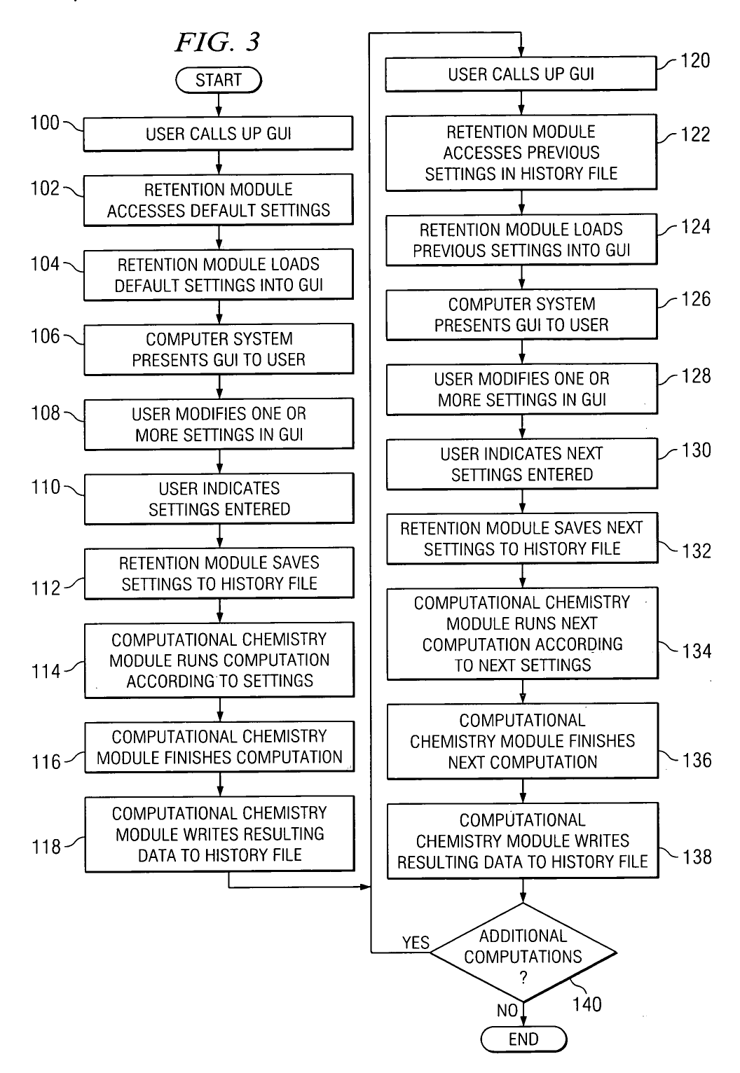

FIG. 3 illustrates an example method for automatically retaining settings of computations on models of molecules for automatic use in subsequent computations. The method begins at step 100, where a user at computer system 12 calls up a GUI 30 for entering the settings of a computation on a model of a molecule. Computational chemistry module 14 has already generated the model of the molecule according to input from the user and stored the model in a memory containing computational chemistry data 18. At step 102, retention module 16 accesses default settings of the computation. Computational chemistry data 18 includes the default settings. At step 104, retention module 16 loads the default settings into GUI 30. At step 106, computer system 12 presents GUI 30 to the user. At step 108, the user modifies one or more settings in GUI 30 to specify the computation the user wants to run. At step 110, the user provides input to computational chemistry module 14 that indicates the user has finished entering the settings of the computation. At step 112, retention module 16 write the settings to a history file in a memory containing computational chemistry data 18. At step 114, computational chemistry module 14 runs the computation according to the settings. At step 116, computational chemistry module 14 finishes the computation. At step 118, computational chemistry module 14 writes the resulting data to the history file.

At step 120, to initiate a next computation on the model of the molecule, the user calls up GUI 30. At step 122, retention module 16 accesses the previous settings in the history file. At step 122, retention module 16 loads the previous settings into GUI 30. At step 124, computer system 12 presents GUI 30 to the user. At step 126, the user modifies one or more settings in GUI 30 to produce the next settings. At step 128, the user provides input to computational chemistry module 14 that indicates the user has finished entering the next settings. At step 130, retention module 16 saves the next settings to the history file. At step 132, computational chemistry module 14 runs the next computation according to the next settings. At step 134, computational chemistry module 16 finishes the next computation and writes the resulting data to the history file. At step 136, if the user has finished running computations on the model, the method ends. At step 136, if the user wants to run one or more additional computations on the model, the method returns to step 120. The present invention contemplates any suitable steps of the method illustrated in FIG. 3 occurring in any suitable order.

Particular embodiments have been used to describe the present invention, and a person having skill in the art may comprehend one or more changes, substitutions, variations, alterations, or modifications within the scope of the appended claims. The present invention encompasses all such changes, substitutions, variations, alterations, and modifications.

What is claimed is:

1. A system for automatically retaining one or more settings of a computation on a model of a molecule for automatic use in a subsequent computation, the system comprising:
a retention module operable to:
automatically record one or more first settings of a first computation on a model of a molecule, the first computation being operable to generate first data useable to assess one or more first properties of the molecule; and
automatically load one or more of the first settings into a second computation on the model, the second computation being operable to generate second data useable to assess one or more second properties of the molecule, retention of one or more of the first settings facilitating comparability between the first data resulting from the first computation and the second data resulting from the second computation.

2. The system of claim 1, wherein the retention module is a component of a computational chemistry module operable to generate the model of the molecule, run the first and second computations, or both.

3. The system of claim 1, wherein the first and second computations comprise three-dimensional geometry optimization.

4. The system of claim 1, wherein the first settings, second settings, or both comprise one or more of:
one or more settings specifying one or more parameter sets;
one or more settings specifying one or more multiplicities;
one or more settings specifying one or more solvent fields;
one or more settings specifying one or more optimization methods;
one or more settings specifying one or more geometry optimizations;
one or more settings specifying one or more convergence criteria;
one or more settings specifying one or more configuration interactions; and
one or more settings specifying one or more key words;

5. The system of claim 1, wherein, to automatically record the first settings, the retention module accesses the first settings in a graphical user interface (GUI) and writes the first settings to a memory.

6. The system of claim 1, wherein the retention module is further operable to write the first settings to a file that is communicable between computer systems, communication of the file enabling execution of the second computation according to one or more of the first settings at one or more computer systems remote from the retention module.

7. The system of claim 1, wherein, to automatically load the first settings into the second computation, the retention module loads the first settings into a graphical user interface (GUI) for entering settings, the GUI enabling a user to modify one or more of the first settings in the GUI to produce one or more second settings for the second computation.

8. The system of claim 1, wherein the retention module is further operable to automatically load one or more default settings into the first computation, the second computation, or both.

9. The system of claim 1, wherein:
the first computation assesses one or more gas-phase properties of the molecule; and
the second computation assesses one or more properties of the molecule in a particular environment.

10. The system of claim 1, wherein the retention module is further operable to:
generate a history file corresponding to the model of the molecule, a memory coupled to the retention module storing the history file;
to automatically record the first settings, write the first settings to the history file; and
to automatically load one or more of the first settings into the second computation, retrieve one or more of the first settings from the history file.

11. The system of claim 10, wherein the retention module is further operable to write the first data resulting from the first computation and the second data resulting from the second computation to the history file.

12. The system of claim 1, wherein the first and second computations are part of a series of more than two computations on the model of the molecule.

13. A method for automatically retaining one or more settings of a computation on a model of a molecule for automatic use in a subsequent computation, the method comprising:
automatically recording one or more first settings of a first computation on a model of a molecule, the first computation being operable to generate first data useable to assess one or more first properties of the molecule; and
automatically loading one or more of the first settings into a second computation on the model, the second computation being operable to generate second data useable to assess one or more second properties of the molecule, retention of one or more of the first settings facilitating comparability between the first data resulting from the first computation and the second data resulting from the second computation.

14. The method of claim 13, executed by a retention module in a computational chemistry module, the computational chemistry module being operable to generate the model of the molecule, run the first and second computations, or both.

15. The method of claim 13, wherein the first and second computations comprise three-dimensional geometry optimization.

16. The method of claim 13, wherein the first settings, second settings, or both comprise one or more of:
one or more settings specifying one or more parameter sets;
one or more settings specifying one or more multiplicities;
one or more settings specifying one or more solvent fields;
one or more settings specifying one or more optimization methods;
one or more settings specifying one or more geometry optimizations;
one or more settings specifying one or more convergence criteria;
one or more settings specifying one or more configuration interactions; and
one or more settings specifying one or more key words;

17. The method of claim 13, wherein automatically recording the first settings comprises accessing the first settings in a graphical user interface (GUI) and writing the first settings to a memory.

18. The method of claim 13, further comprising writing the first settings to a file that is communicable between computer systems, communication of the file enabling execution of the second computation according to one or more of the first settings at one or more computer systems remote from the retention module.

19. The method of claim 13, wherein automatically loading the first settings into the second computation comprises loading the first settings into a graphical user interface (GUI) for entering settings, the GUI enabling a user to modify one or more of the first settings in the GUI to produce one or more second settings for the second computation.

20. The method of claim 13, further comprising automatically loading one or more default settings into the first computation, the second computation, or both.

21. The method of claim 13, wherein:
the first computation assesses one or more gas-phase properties of the molecule; and
the second computation assesses one or more properties of the molecule in a particular environment.

22. The method of claim 13:
further comprising generating a history file corresponding to the model of the molecule, a memory coupled to the retention module storing the history file; and
wherein:
automatically recording the first settings comprises writing the first settings to the history file; and
automatically loading one or more of the first settings into the second computation comprises retrieving one or more of the first settings from the history file.

23. The method of claim 22, further comprising writing the first data resulting from the first computation and the second data resulting from the second computation to the history file.

24. The method of claim 13, wherein the first and second computations are part of a series of more than two computations on the model of the molecule.

25. Logic for automatically retaining one or more settings of a computation on a model of a molecule for automatic use in a subsequent computation, the logic encoded in media for execution and when executed operable to:
automatically record one or more first settings of a first computation on a model of a molecule, the first computation being operable to generate first data useable to assess one or more first properties of the molecule; and
automatically load one or more of the first settings into a second computation on the model, the second computation being operable to generate second data useable to assess one or more second properties of the molecule, retention of one or more of the first settings facilitating comparability between the first data resulting from the first computation and the second data resulting from the second computation.

26. The logic of claim 25, encoded in a retention module in a computational chemistry module, the computational chemistry module being operable to generate the model of the molecule, run the first and second computations, or both.

27. The logic of claim 25, wherein the first and second computations comprise three-dimensional geometry optimization.

28. The logic of claim 25, wherein the first settings, second settings, or both comprise one or more of:
one or more settings specifying one or more parameter sets;
one or more settings specifying one or more multiplicities;
one or more settings specifying one or more solvent fields;
one or more settings specifying one or more optimization methods;
one or more settings specifying one or more geometry optimizations;
one or more settings specifying one or more convergence criteria;
one or more settings specifying one or more configuration interactions; and
one or more settings specifying one or more key words;

29. The logic of claim 25, operable, to automatically record the first settings, to access the first settings in a graphical user interface (GUI) and writing the first settings to a memory.

30. The logic of claim 25, further operable to write the first settings to a file that is communicable between computer systems, communication of the file enabling execution of the second computation according to one or more of the first settings at one or more computer systems remote from the retention module.

31. The logic of claim 25, operable, to automatically load the first settings into the second computation, to load the first settings into a graphical user interface (GUI) for entering settings, the GUI enabling a user to modify one or more of the first settings in the GUI to produce one or more second settings for the second computation.

32. The logic of claim 25, further operable to automatically load one or more default settings into the first computation, the second computation, or both.

33. The logic of claim 25, wherein:
the first computation assesses one or more gas-phase properties of the molecule; and
the second computation assesses one or more properties of the molecule in a particular environment.

34. The logic of claim 25, further operable to:
generate a history file corresponding to the model of the molecule, a memory coupled to the retention module storing the history file;
write the first settings to the history file to automatically record the first settings; and
retrieve one or more of the first settings from the history file to automatically load one or more of the first settings into the second computation.

35. The logic of claim 31, further operable to write the first data resulting from the first computation and the second data resulting from the second computation to the history file.

36. The logic of claim 25, wherein the first and second computations are part of a series of more than two computations on the model of the molecule.

37. A system for automatically retaining one or more settings of a computation on a model of a molecule for automatic use in a subsequent computation, the system comprising:
means for automatically recording one or more first settings of a first computation on a model of a molecule, the first computation being operable to generate first data useable to assess one or more first properties of the molecule; and
means for automatically loading one or more of the first settings into a second computation on the model, the second computation being operable to generate second data useable to assess one or more second properties of the molecule, retention of one or more of the first settings facilitating comparability between the first data resulting from the first computation and the second data resulting from the second computation.
